(19) United States
(12) Patent Application Publication
(10) Pub. No.: US 2025/0334442 A1
(43) Pub. Date: Oct. 30, 2025

(54) A WATER LEVEL MONITORING SYSTEM

(71) Applicants: Jonas BENSCH, Leuven (BE); Thomas VAN AKEN, Moerbeke (BE); Xavier DECUYPER, Deinze (BE)

(72) Inventors: Jonas BENSCH, Leuven (BE); Thomas VAN AKEN, Moerbeke (BE); Xavier DECUYPER, Deinze (BE)

(73) Assignees: Jonas BENSCH, Leuven (BE); Thomas VAN AKEN, Moerbeke (BE); Xavier DECUYPER, Deinze (BE)

(21) Appl. No.: 18/868,305

(22) PCT Filed: May 25, 2023
(86) PCT No.: PCT/EP2023/064133

§ 371 Date: Nov. 22, 2024

(30) Foreign Application Priority Data
May 25, 2022 (EP) 22175551.5

(51) Int. Cl. G01F 23/62; A01G 31/00; G01F 25/20; G08B 21/18

(52) U.S. Cl. CPC G01F 23/62; G01F 25/20; G08B 21/182; A01G 31/008

(57) ABSTRACT

The current disclosure relates to a water level monitoring system for monitoring a water level in a hydroponic system, such as a LECA system being a “lightweight expanded clay aggregate” system or any other semi-hydroponic system or passive hydroponic system. The disclosure further relates to a corresponding method to monitor the water level in a hydroponic system, like for instance a LECA system or any other semi-hydroponic system or passive hydroponic system.

### FIELD OF THE INVENTION

The present invention generally relates to a water level monitoring system for monitoring a water level in a hydroponic system, such as a LECA system (being a “lightweight expanded clay aggregate” system) or any other semi-hydroponic system or passive hydroponic system. The invention further relates to a corresponding method to monitor the water level in a hydroponic system, like for instance a LECA system or any other semi-hydroponic system or passive hydroponic system.

### BACKGROUND

Hydroponic systems nowadays become more and more popular in the cultivation of plants. A hydroponic system may be a water-or hydroculture system such as a deep-water culture or a nutrient film hydroponic system. But the interest in hydroponic systems being LECA systems, or any other semi-hydroponic systems or passive hydroponic systems, grew in private use. The hydroponic system being a LECA system, or any other semi-hydroponic systems or passive hydroponic systems became also very popular for use in larger areas, like office spaces, shopping malls, airports, lobbies of hotels and alike.

In LECA systems, and any other semi-hydroponic systems or passive hydroponic systems, the hydroponic plant cultivation relies on the use of porous, water-absorbing substrate in which the roots of plants grow. This technique is in contrast with regular plant cultivation, wherein soil is used in contact with the plants' roots, or hydroculture wherein the plants grow with their roots in water only. In hydroculture, the presence of water during so-called wet periods, and the non-presence of water during so-called dry periods in time is crucial.

One of the most important aspects in LECA systems, as well as in any other semi-hydroponic systems or passive hydroponic systems, is the timely adding of water to plants in order to maximize their lifetime and appearance.

Typically, there is a water retention volume under the absorbing material or at the bottom of the water-absorbing material. The water level is made visible by a plastic tube in which a floating device (e.g., a plastic ball pushing a long plastic pin or rod) moves upwards due to the Archimedes forces acting on the ball. The level of the ball is made visible by the end of the pin or rod which indicates in a transparent tube the height of the water in reference to a minimum and maximum level indicated on the tube.

Monitoring the water level is done visually and requires for instance daily human inspection. The plant needs to be provided with fresh water to generate a wet period, after e.g., 4 days to 8 days (depending on the plant variety) of a dry period. The length of wet and dry periods is dependent on the type of plants and the season, and hence may vary over time and between different hydroponic systems.

Often the person monitoring the water level of plants forgets to fill or fills too early. In particular in office spaces, hotels, airports and alike where a large number of plants of different varieties have to be monitored, the lifetime and appearance of plants reduces substantially as a result of inappropriate water filling based on human inspection of the water filling level.

There is a need for an improved system to monitor the water level in a hydroponic system in general.

### SUMMARY OF THE INVENTION

According to a first aspect of the invention, a water level monitoring system for monitoring a water level in a hydroponic system is provided. The water level monitoring system comprises:
a floating means, comprising a floating body and at least one magnet, said water level monitoring system being adapted to monitor the position of said floating means;
a monitoring means for monitoring the position of said floating means floating on the water level in a hydroponic system and generating a monitoring result, based on a magnetic field produced by said magnet;
a processor configured to process said monitoring result and determine therefrom a water level for the hydroponic system; and
an alerting unit configured to generate an alert signal based on said water level.

Preferred embodiments of the device are shown in any of the claims 2 to 9. A specific preferred embodiment relates to an invention according to claim 2.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIGS. 1a and 1b shows a schematic view of a hydroponic system known in prior art.

FIGS. 2a and 2b are schematic views of a monitoring means being part of a water level monitoring system of a hydroponic system according to the invention.

FIGS. 2c and 2d are schematic views of a hydroponic system according to the invention comprising the monitoring means of FIGS. 2a and 2b.

FIG. 2e is a schematic isometric view of the monitoring means shown in FIGS. 2a and 2b.

FIG. 2f is a schematic exploded view of the components of the monitoring means shown in FIGS. 2a and 2b. FIG. 2g is a schematic view of the backside of the printed circuit board part of the monitoring means shown in FIGS. 2a and 2b.

FIGS. 3a and 3b are schematic views of a monitoring means being part of a water level monitoring system of a hydroponic system according to the invention.

FIGS. 3c and 3d are schematic views of a hydroponic system according to the invention comprising the monitoring means of FIGS. 3a and 3b.

FIG. 3e is a schematic isometric view of the monitoring means shown in FIGS. 3a and 3b.

FIG. 3f is a schematic exploded view of the components of the monitoring means shown in FIGS. 3a and 3b. FIG. 3g is a schematic view of the backside of the printed circuit board part of the monitoring means shown in FIGS. 3a and 3b.

FIGS. 4a and 4b show schematically how the monitoring means of FIGS. 2a, 2b, 3a and 3b can slide over a floating means, which may optionally be a floating means according to the prior art.

FIGS. 4c and 4d show schematically how the monitoring means of FIGS. 7a-7g can slide over a floating means, which may optionally be a floating means according to the prior art.

FIGS. 5 and 6 show schematically the working of a water level monitoring system according to the invention.

FIGS. 7a and 7b are schematic views of a monitoring means being part of a water level monitoring system of a hydroponic system according to the invention.

FIGS. 7c and 7d are schematic views of a hydroponic system according to the invention comprising the monitoring means of FIGS. 7a and 7b.

FIG. 7e is a schematic isometric view of the monitoring means shown in FIGS. 7a and 7b.

FIG. 7f is a schematic exploded view of the components of the monitoring means shown in FIGS. 7a and 7b. FIG. 7g is a schematic view of the backside of the printed circuit board part of the monitoring means shown in FIGS. 7a and 7b.

### DETAILED DESCRIPTION OF THE INVENTION

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The water level monitoring system may be adapted for monitoring a water level in any hydroponic system, though preferably is adapted for monitoring a water level in a LECA system or any other semi-hydroponic system or a passive hydroponic system.

The water level monitoring system according to the present invention is an improved system to monitor the water level in a hydroponic system. The water level monitoring system according to the present invention makes a combination of monitoring the position of the floating means, processing the position and generating an alert for the user, while this water level monitoring system does not require any human intervention. The system is independent of the discipline and accuracy of a user, and hence is more reliable. Human inspection often may lack regularity and/or accuracy. Human inspection on the spot is no longer needed when using a water level monitoring system according to the present invention.

The water level monitoring system can also take into consideration the diverse plants and/or plant variations present in the monitored system and may take into account the different needs of such diverse plants and/or plant variations. This diversity, in particular when different plants and/or plant variations are combined in one hydroponic system, is often too complex for human monitoring and intervention to be done accurately based upon human inspection only. When not combined into a single hydroponic system, different varieties of plants in different hydroponic systems may require different water filling times, which is also difficult to manage by a human.

In a first aspect, the invention provides a water level monitoring system for monitoring a water level in a hydroponic system, the water level monitoring system comprising:
a floating means, comprising a floating body and at least one magnet, said water level monitoring system being adapted to monitor the position of said floating means;
a monitoring means for monitoring the position of said floating means floating on the water level in a hydroponic system and generating a monitoring result, based on a magnetic field produced by said magnet;
a processor configured to process said monitoring result and determine therefrom a water level for the hydroponic system; and
an alerting unit configured to generate an alert signal based on said water level.

According to some embodiments, the water level monitoring means may comprise a floating means, said water level monitoring system being adapted to monitor the position of said floating means floating on the water level in the hydroponic system. The floating means and the monitoring means may be designed to cooperate, which may increase the level of accuracy of the monitoring means and the water level monitoring system.

In a preferred embodiment, the monitoring means for monitoring the position of a floating means is preferably a magnetic field detection system. Magnetic field detection systems require the least interaction with the hydroponic system, while a reliable and accurate monitoring result can be obtained. Besides this, magnetic field detection systems can be easily finetuned and are maintenance-free, even more so because the detection principle is contactless, thus resulting in less mechanical problems that would require intervention or maintenance. The proposed invention separates the ‘conventional’ analogue floater from the innovative magnetic detection system, thus avoiding any issues between the two parts.

The water level monitoring system according to the invention may be used to monitor the water level of existing hydroponic systems, which are equipped with a floating means floating on the water level in the hydroponic system. In some cases, where the monitoring means is compatible with the floating means of the existing hydroponic system, the monitoring means can be mounted on the floating means to monitor the position of the floating means. In other cases, where the monitoring means is incompatible with the floating means of the existing hydroponic system, the floating means of the existing hydroponic system may be replaced by a floating means being part of the water level monitoring system according to the invention, and the monitoring means can monitor the position of the floating means being part of the water level monitoring system according to the invention. In other cases, where the floating means of the existing hydroponic system cannot be replaced by a floating means being part of the water level monitoring system according to the invention, a floating means being part of the water level monitoring system according to the invention may be added to the hydroponic system, and the monitoring means can monitor the position of the floating means being part of the water level monitoring system according to the invention.

An advantage of the present system using magnetic interaction to detect the water level, is that this can accomplished in very compact devices. The monitoring means does not need a minimal focal distance to the magnet, in fact the opposite is true. Electronic systems currently used in water level detection are often large, consume a lot of power, generate additional heat, and other issues, all of which do not need to be addressed in the present invention.

In a particularly preferred embodiment, the processor is configured to calibrate itself by automatically determining the water level to be at a lowest (empty) state when the monitoring results remain substantially constant for at least a predetermined period of time. This allows the system to assign the empty status to a certain magnetic field reading, which it can then use to determine water levels or filling states in the future from future monitoring results. This is in particular useful for modular systems where the monitoring means is removable, and can over time be placed on separate floating means on separate hydroponic systems. A potential danger is that the magnetic field associated to the empty (or full) state of the water level in a first system may not be the same for a second or third system, meaning that the user is either incorrectly informed, or needs to manually set this each time they move the monitoring means. By having an automatically calibrating system, this is resolved. In particular, it is useful to calibrate based on an empty state, as this is the only state in which the level is constant over a reliable period of time, especially since so-called dry periods are mandatory for plants, in which the soil can aerate and (re)absorb oxygen. While this means that the readings may be inaccurate at first, the system is assured to calibrate itself automatically and correctly. What is particularly useful in this embodiment, is that the monitoring means can be used in conjunction with any floating means which has a magnet, making it entirely device agnostic.

The determination of the monitoring results remaining substantially constant is preferably evaluated over a longer period of time, for instance at least 5 minutes, or at least 10 minutes. Preferably, this is at least 15 minutes or even 20 minutes. More preferably, it is at least 30 minutes, 45 minutes or 1 hour. Even more preferably, the predetermined period of time is at least 2 hours, or 4 hours or 6 hours. Even more preferably, it is at least 12 hours or 24 hours or 48 hours. Most preferably it is at least 96 hours or 192 hours.

It is preferred that the predetermined period of time is capped, in order to be able to evaluate the status within a certain time frame, and furthermore avoiding that a refill may take place within said time frame (or even incorrect readings could result in a seeming variation). As such, the predetermined period of time is preferably at most 192 hours, but preferably less, such as 96 hours or 48 hours, or even 24 hours. Even shorter periods can be considered, for instance at most 12 hours, 6 hours, 4 hours, 2 hours or 1 hour, and even 45 minutes, 30 minutes, 20 minutes, 15 minutes or 10 or 5 minutes. Such a limitation allows the requirements for what is considered as constant to be set stricter, as well as allowing quicker evaluations.

The evaluation of constancy can be performed via a number of ways, for instance a predetermined percentage or even absolute value in which the magnetic field can fluctuate over said period of time, in view of a running average over a certain length of time. The allowed fluctuation can for instance be 20%, 15%, 10%, 5% or less, such as 2.5%, 2% or even less, with respect to a benchmark value for a preceding period of time.

The length of time can be more or less than the period of time over which constancy is demanded. Preferably, the length of time is longer, in order to avoid situations where the monitoring results slowly fall or rise, which could result in the change not being observed. Furthermore, this can be used to quantify such empty states in duration, making sure that a necessary length of the dry state is achieved (for instance at least 96 hours). As such, it can be performed in a way that the sum of the period of time and the length of time is at least equal to said necessary length of the dry/empty state for the hydroponic system. In some embodiments, one or more of these time periods can be set by the user (for instance, the total time period).

As such, the length of time is preferably at least 30 minutes or 1 hour, more preferably at least 2 hours, or even 3 or 4 hours. More preferably, the length of time is at least 6 hours or 12 hours. Even more preferably, it is at least 24 hours or 48 hours or even 72 hours. More preferably, it can be at least 96 hours or even 192 hours or 384 hours.

Again, it is often preferable to set a limit to the length of time, for instance at most 384 hour or 192 hours. More preferably it is at most 96 hours or 72 hours. Preferably, it is at most 48 hours or 24 hours or 12 hours. Preferably, it is at most 6 hours, 4 hours or 3 hours. Preferably, it is at most 2 hours, or 1 hour. Preferably, it is at most 45 minutes or at most 30 minutes.

In some embodiments, the processor is provided incorporated with the monitoring means in a single shell. In other embodiments, the processor is external with respect to the monitoring means (and the hydroponic system), for instance a cloud-native processor (CNP). While this could still mean a processor is present at the monitoring means, it does not determine the water levels and similar steps, but instead can be used for driving the monitoring means, controlling processes for the components at the hydroponic system, such as forwarding the measurements to a remote processor at which they are processed further. This can reduce the amount of computational load on the device at the hydroponic system, and thus reduce power consumption. Of course, some actions can be performed locally, for instance averaging of a plurality of measurement samples into an averaged magnetic field to reduce noise on the signal (or balance errors), as performing this locally reduces the amount of data to be sent. Preferably, the steps of determining the water level are performed remotely, as is the calibration process.

In a preferred embodiment, most preferably combined with the above auto-calibration, the system can be manually calibrated by a user, setting a reference value of the water level for the system to associate with the magnetic field at that time. This is preferably kept simple, for instance that the reference value is equal to the lowest (empty) water level for the system, or inversely the highest (full) water level for the system. These settings require no advanced input from the user and can be actuated very simply, for instance via a single button or other physical trigger on the system. However, in some cases, this can be performed via an app or external electronic device, in which case more complex inputs are also easier, and could allow the user to input very specific water level conditions instead of “full” or “empty”.

In a preferred embodiment, the floating means is provided in an elongate tube, in which the magnet and floating body are present, and which is in communication with the water in (the soil of) the hydroponic system. This allows the magnet and floating body to move unimpeded by other elements in the hydroponic system, and guides the elements along a fixed path, allowing the position of the elements to be measured and interpreted correctly via the monitoring means and processor.

Preferably, the tube has a narrow internal opening in which the magnet and floating body can move, to assure that the movements are restricted to the fixed path, with minimal variations (for instance, from the magnet and floating body lying askew of the longitudinal axis of the tube), as the variations can impact the position of the magnet with respect to the monitoring means.

The tube has an opening at or near the bottom end and is in fluid communication with the water inside of the hydroponic system, for instance by positioning it in the soil or in a water reservoir. This means that the water level in the tube will have the same height as in the hydroponic system. As such, the floating body will float on the water in the tube, thus pushing the magnet upwards (or downwards) with it as the water level rises or recedes, thus varying the magnetic field measured at the monitoring means.

In a preferred embodiment, the monitoring means comprises a holding means holding the monitoring means. The holding means is adapted to be securely attached to the tube at a superior end thereof, typically on top, or laterally adjacent to the top. This means the monitoring means will be outside of the soil or container of the hydroponic system, allowing it to be placed, switched out or adjusted easily, and avoids (excessive) contact with the soil, water and other external influences that could influence the device. In particular, a detachable monitoring means allows for batteries being replaced or charged, electronics being adjusted or updated, and means that the devices can be moved between hydroponic systems without any issues.

In a preferred embodiment, the monitoring means and the processor are provided in a single shell, which is removably attachable to a container for holding the floating means, such as a tube. The container can be an integrated part of the hydroponic system, or can be a separate part. As mentioned previously, the monitoring means can be attached at the top of the container, in the extension thereof, or laterally at the top. Attachment can be via a plethora of techniques, such as a clip-on, friction-based attachment, Velcro (or similar), screws.

In a preferred embodiment, the monitoring means and the processor are provided in a single shell, which is substantially flat. The shell is provided with an attachment means for removable attachment to an elongate container wherein the floating means is held, with the magnetometer being centered with respect to the container such that it is on-axis with the floating means itself. This provides a maximally reliable reading of the magnetic field.

In a preferred embodiment, the monitoring means comprises a main magnetometer and one or more support magnetometers. The main magnetometer and the support magnetometer(s) are most preferably positioned at a different distance from the longitudinal axis of the tube. This means that the magnetometers can experience different readings from the magnetic field, depending on the exact position of the magnet. Applicant finds that this is particularly helpful in some occasions where small variations of the magnetic field may have a strong impact on the determined position of the magnet, and the water level that is determined therefrom. The floating body and magnet can by their orientation influence the magnetic field, while the water level is constant. For instance, by the floating body and magnet lying askew or being upright with respect to the longitudinal axis of the floating means (or of the tube), the floating body will be at the water level in both cases, but the position of the magnet in terms of distance to the monitoring means will be different. When the magnet is far away from the monitoring means, the impact will be limited, but in close proximity, this variation will influence the result much more strongly.

By providing multiple magnetometers, which are positioned separately, but preferably at the same ‘height’ along the longitudinal axis of the floating means, this variation can be taking into account or even entirely removed from the readings, depending on the number of magnetometers and their position.

The positioning of the magnetometers can depend on the shape of the monitoring means and/or the position of the monitoring means with respect to the floating means. In a particular embodiment, the monitoring means is positioned directly above, as a ‘cap’ on the floating means. In such a case, placing a magnetometer directly on the longitudinal axis of the floating means is preferred, in particular as the main magnetometer. One or more support magnetometers can then be positioned off-axis, around the main magnetometers, of which the readings can show whether the magnet of the floating means is off-center with respect to the longitudinal axis. Alternatively, each of the magnetometers can be positioned off-axis, centered around the axis, preferably along the perimeter of a circle (with two, three or more magnetometers positioned under equal angles, such as at 0°, 120° and 240° in case of three magnetometers).

In another embodiment, the monitoring means can be attached laterally to the floating means, meaning that the magnetometer will be off-axis by definition. Again, by providing multiple magnetometers, at the same height, a more exact position can be determined for the magnet even in situations where the magnet and floating body are tilted, by taking into account the relative positions of the magnetometers.

As a further advantage, the presence of multiple magnetometers provides for a redundancy in case of issues with one of the magnetometers.

In a preferred embodiment, the processor is configured to determine the water level based on a plurality of measurements of the magnetic field by the monitoring means, said plurality comprising at least 5, preferably at least 10, more preferably at least 20, samples, wherein said measurements are taken over a maximal time frame of 1 minute, preferably of 30 seconds, more preferably at most 10 seconds or even 5 or 1 seconds, and most preferably wherein the water level is determined based on an average of said plurality of measurements. One of the inherent features of this technology is small size. As such, in order to occupy minimal volume, both for ease of placement, maximal volume for soil and plants, as well as aesthetic purposes, the electronics used in the device are specifically chosen to enable a maximal reduction in size. However, this often means that cost increases but also that accuracy/speed/efficiency/ . . . is reduced in view of large-scale electronic components. What is also relevant, is that the distances over which the magnet position in view of the magnetometer(s) changes, is relatively small.

All of the above combines to define an invention where small variations and external influences can quickly stack up to impact the ultimate result (i.e., determined water level) quite severely if not taken into account. As such, by evaluating the water level not via single-shot measurements of the magnetic field, but by multiple measurements or samples, variations can be identified (for instance in case of short-term cyclical variations), aberrant measurements (errors) can be identified, and these influences can removed or smoothed out by averaging.

Preferably, at least 5 such measurements are used each time, but higher numbers can of course increase the reliability, for instance 10, 15, 20, 30, 50, etc. It is preferable to take these measurements over a relatively short time interval, to avoid drastic changes (for instance, watering the system). Therefore, a maximal time frame of 1 minute is taken. Shorter time frames, for instance 30 seconds or less, such as 20, 15, 10, 5, 1 seconds or less, are also possible. It is however in some cases interesting to define a minimal time frame, for instance 1 second, 2 seconds, 5 seconds or more, such as 10 seconds, 15 seconds, etc., in order to be able to identify (and remove/account for) any cyclic influences on the measurements.

The steps of evaluating the separate measurements and processing these into a single value (averaged measurement, or even a determined water level) is preferably done on the device itself, to avoid needing to send large amounts of data (X separate measurements) to an external device.

In a preferred embodiment, the monitoring means is configured to effectively measure the magnetic field periodically, in order to save energy. The period can be manually set, but is preferably predetermined between 1 minute and 6 hours, preferably between 5 minutes and 3 hours, more preferably between 10 minutes and 2 hours, even more preferably between 15 minutes and 1 hour, and most preferably between 25 minutes and 40 minutes, such as 30 minutes.

In a preferred embodiment, the monitoring means has a maximal thickness (minimal dimension of the monitoring means), of at most 5.0 cm, preferably at most 4.0 cm, more preferably at most 3.0 cm, even more preferably at most 2.5 cm. Even more preferably, the thickness is at most 2.0 cm, 1.5 cm or even less, such as 1.0 cm or 0.5 cm. This way, the monitoring means is kept compact. The above can be accomplished as the monitoring means can be implemented on a simple PCB (standard thickness is about 1.57 mm, but can be reduced further) with one or more sensing elements for magnet field detection. Additionally, a thin battery can be implemented, for instance at a thickness similar to a PCB.

The length (maximal dimension) is preferably at least 1.0 cm, preferably at least 2.0 cm, more preferably at least 3.0 cm and even more preferably at least 4.0 cm. This is usually dictated by the minimal dimensions of the electronics used, for instance the PCB. Increasing the length does not impact the practicality, and in fact allows a specific embodiment in which more accurate assessments of the filling state is possible, as will be discussed further on for embodiments with multiple magnetometers which are spaced apart along the length of the monitoring means.

In a preferred embodiment, the floating means extends substantially longitudinal, and the monitoring means is substantially flat and configured to be removably connected to the floating means (indirectly, preferably removably connectable to a tube or other holding means in which the floating means is suspended) such that it is suspended perpendicular to the floating means. In a further preferred embodiment, the monitoring means comprises a single magnetometer, and is suitable for detecting the longitudinal position of the magnet of the floating means by means of the magnetic field detected. As only a single measurement/detection position is required for the monitoring means along the longitudinal axis of the floating means, the PCB can be held perpendicularly, thus limiting the vertical space required for the monitoring means (as its thickness can be kept very low). The monitoring means can be in the form of a plaque, card or another shape.

Alternatively, the monitoring means can be suspended parallel to the longitudinal axis, if this is more appropriate, as in some embodiments available horizontal space is limited. The thickness of the monitoring means is relatively low, and it will largely extend along the longitudinal axis of the floating means.

In other embodiments, the floating means extends substantially longitudinal, and the monitoring means is substantially flat, and configured to be removably connected to the floating means (indirectly, preferably removably connectable to a tube or other holding means in which the floating means is suspended), such that it is suspended parallel to the floating means. In such an embodiment, the monitoring means comprises multiple magnetometers, for instance in the form of switches or Hall effect sensors, and are spaced apart on the monitoring means along the longitudinal axis of the floating means when connected. This makes it more efficient to have the monitoring means extend along the floating means, thus minimizing the space it takes up. Furthermore, this way, the position of the floating means, and thus the water level, can be monitored in discrete stages, giving a more accurate overview for the user. Preferably, the monitoring means is connected to the floating means at at least two positions, to ensured it maintains a parallel orientation.

In a preferred embodiment, the monitoring means comprises one or more magnetometers, configured to detect said magnetic field of said magnet and wherein said water level is determined by the strength of said detected magnetic field.

As an example, the monitoring means may comprise one or more magnetometers, which are positioned along the position range where the magnet of the floating means may be present. The monitoring result may be a specific magnetometer in a triggered state due to the nearby magnetic field of the floating means whereby the position of the floating means can be deducted. As another example, the monitoring result may be determined by the measurement of the strength of a magnetic field by one magnetometer, wherefor a specific strength is equivalent to a specific position. A processor may process this result and may determine what the water level is in the hydroponic system based upon this monitoring result. An advantage of magnetometers is that these devices may be used to monitor the floating means during daytime as well as during night-time.

In a preferred embodiment, the monitoring means comprises at least two magnetometers, positioned at predefined intervals, and configured to detect said magnetic field of said magnet and wherein said water level is determined by the strength of said magnetic field detected by at least one, preferably each, of the at least two magnetometers.

The use of a magnetic field system as a detection system is however preferred. Magnetometers such as Hall effect sensors or MEMS magnetic field sensors may have very small dimensions. Such small sensors are readily available even at low cost nowadays. Their smaller dimensions allow the integration in a relatively small monitoring system. Accordingly, the use of magnetometers allows the whole water level monitoring system to be relatively small. As such, a water level monitoring system may be provided which does not disturb the overall appearance of a hydroponic system and/or provide no obstruction for the plants of the hydroponic system. The detection signals, which are generated by the sensors, can be accurately processed via a digital circuit with a dedicated programmable microcontroller.

According to some embodiments, the magnetometers are Hall effect sensors, configured to act as a binary switch and to trigger upon exceedance of a magnetic threshold of said magnetic field and wherein said water level is determined by said triggered Hall effect sensor. The Hall effect sensors may be positioned along the position range where the magnet of the floating means may be present. These Hall sensors hence are positioned all along the length defined by the two extrema being the position when the hydroponic system is in fully filled or overfilled condition, and the empty condition. These are discrete measurements and generate digital signals. The Hall sensors are combined with threshold detection to act as a binary switch. Hall effect sensors respond to static (non-changing) magnetic fields. When used as electronic switches, they are less prone to mechanical failure since there is no wear on physical parts.

According to some embodiments, the magnetometer is a micro-electro-mechanical system (MEMS), more specifically a MEMS magnetic field sensor. MEMS magnetic field sensors operate by detecting effects of the Lorentz force, a change in voltage or resonant frequency may be measured electronically. Here, only one MEMS magnetic field sensor is required in the monitoring system. The MEMS magnetic field sensor is positioned along the position range where the magnet of the floating means may be present and measures the strength of the magnetic field. The output of a measurement made by a magnetic field sensor is a continuous and analogue value, which represents the strength of the magnetic field. The continuous value may be converted to a digital signal, whereby a further digital circuit compares the digital value to a known reference value. Concludingly, based on the difference between the measured and the reference value, the relative position of the magnet, hence floating means, can be determined. Integration of MEMS sensor and microelectronics can further reduce the size of the entire magnetic field sensing system.

The use of a magnet with magnetometers has the advantage that the system is very accurate and that the used floating means may still be used. The water level monitoring system according to the invention may make use of the floating means as presently available for hydroponic systems and has no influence on the performance of these floating means. As such the floating means as presently used (hereafter the analog system) still provide a fallback system in case the water level monitoring system according to the invention fails, e.g., due to low battery tension or damage. Another advantage is that during filling of the hydroponic system, the person filling the hydroponic system can still rely on the analog system to see to what extent water further needs to be added.

According to some embodiments, the floating means may comprise at least a tube, the floating means comprising an indication means present along a part of the tube. Such floating means are usually not complex and relatively cheap. They are part of existing technology. The use of such floating means has the advantage that existing floating means from existing hydroponic systems may be used in the provision of a water level monitoring system according to the invention. Possibly existing floating means, optionally comprising a transparent tube in which an indication means is provided, may be monitored by the monitoring means of the invention. In other words, water level monitoring systems according to the invention may be used to upgrade the existing hydroponic system.

According to some embodiments, the water level monitoring system may be adapted to monitor the position of this indication means.

As an example, the floating means may comprise a floating ball, which ball is touching and lifting an indication rod within a tube, typically a polymeric and transparent tube. The water level monitoring system may be adapted to monitor the position of the top of the indication rod within the tube. These floating means are well known and used in the art. The water level monitoring system may be adapted to monitor the floating means of existing hydroponic systems. Monitoring the top of the indication rod in fact is what humans are to do when monitoring the water level of the hydroponic system.

The water level monitoring system may also gather additional data such as temperature, humidity, light intensity and light duration and/or additional information on the condition of the water level monitoring system like remaining battery power and alike. This additional data may also be communicated to the user. Preferably, the water level monitoring system is provided with one or more additional sensors in the monitoring means, for the above purposes of measuring one or more of temperature, humidity, light intensity and/or duration, and potential other information.

According to some embodiments, the water level monitoring means may comprise a holding means holding the monitoring means. The holding means may be adapted to be securely attached to a tube of a floating means of a hydroponic system. Such holding means may be used to retrofit existing hydroponic systems being equipped with a suitable floating means and provide the existing hydroponic system with a water level monitoring system.

According to some embodiments, the processor is configured with artificial intelligence and machine learning to process the monitoring result and determine the water level.

A processor may process this monitoring result being an analogue or digital value and determine what the water level is in the hydroponic system. The processor may use digital signal processing (DSP) algorithms for this processing and/or determination or may use artificial intelligence (AI) and machine learning (ML) for this processing and/or determination.

The monitoring means may constantly monitor the position of the floating means. In the alternative, the monitoring means may comprise a timing means to schedule monitoring moments periodically, at regular time intervals. As an example, regular time intervals between 15 minutes and 6 hours may be used, e.g. every hour, every two hours or every three hours.

According to some embodiments, the processor may be an on-board processor integrated with the monitoring means into a single unit.

The use of an on-board processor has the advantage that no internet connection is needed to operate the water level monitoring system. The system may indicate that water is to be added, or at least to be considered, by alerting the user through an alert signal like an auditive and/or visual signal generated by an alert unit on-board. The signal may be a local signal, i.e. noticeable at or near the hardware of the water level monitoring system. It may e.g. be a visible signal, e.g. a LED-light or similar means being lightened or flashing, which LED-light is present on the hardware of the water level monitoring system. Additionally, or alternatively, the signal may be e.g. an auditive signal, e.g. a beeping signal, being generated by a sound generating means on-board of the hardware of the water level monitoring system.

Additionally, or alternatively, the alert unit may generate a signal which is communicated to a second device, e.g. a smart device like a smart speaker, smartphone, smartwatch, a tablet and alike. This smart device on its turn will provide the user with a signal, like a message or alike. The alert unit and the smart device may communicate through a close proximity communication system, like Bluetooth or other short distance point-to-point technology. Obviously, when combined with internet connectivity, the on-board processor and alerting unit may use alternative ways to communicate the alert signal to the user, using for instance WIFI, 4G, 5G or narrow band IoT wireless networks. The alert signal may be communicated to a software platform bundling a plurality of monitoring means, which thereafter communicates the alert signal to the end-user.

Using an on-board processor, the DSP algorithms and/or the AI/ML may be stored and performed on-board and may optionally be updated on a regular basis via updates. The updates may be obtained from a cloud storage system over the internet, using for instance WIFI, 4G, 5G or narrowband IoT wireless networks.

According to some embodiments, the processor may be a remote processor whereto the monitoring result is transferred via a communication network. DSP algorithms and/or AI/ML may be performed by an external or remote processor. These external DSP algorithms and/or external AI/ML can get updated on a regular basis while being stored in a cloud storage system. The monitoring result may be sent to the cloud storage system over the internet, using for instance WIFI or narrowband IoT wireless networks. Again, the alert unit generates an alert signal, which is communicated to a second device, e.g. a smart device like a smart speaker, smartphone, smartwatch, a tablet and alike, using for instance WIFI, 4G, 5G or narrowband IoT wireless networks. This smart device on its turn will provide the user with a signal, like a message or alike. The alert signal may as well be communicated to a software platform bundling a plurality of monitoring means, which thereafter communicates the alert signal to the end-user. Additionally, the alert unit may be communicated back to the hardware of the water level monitoring system, where a local signal, like a visual or auditive signal, may be generated.

According to some embodiments, the alerting unit may comprise communication means to communicate the alert signal to a smart device of a user, configured with an application to alert the user based on the alert signal.

In case a user is to monitor more than one water level monitoring system for more than one hydroponic system, signals of more than one water level monitoring system may be combined in one alert signal provided to the smart device of a user.

The user may thus obtain an alert or a signal, which alert or signal reflects the status of the hydroponic system or systems he or she is to monitor. The user may be instructed to provide water to one or more hydroponic systems, and not to provide water to other systems. A timely water provision may be obtained for one or more hydroponic systems, resulting in a longer lifetime for the plants grown in the hydroponic systems.

According to some embodiments, the alert signal may be a visual and/or an auditive signal.

According to some embodiments, the alerting unit may comprise communication means to generate a visual and/or auditive signal at the water level monitoring system itself. The visual signal may be a light signal, e.g. a flashing light signal. This system may be useful to locate the hydroponic system to be watered or inspected. According to some embodiments, the alerting unit may comprise communication means to generate a signal and communicate such signal to a smart device, e.g. using an appropriate software application to generate an auditive or visual signal. As an example, an auditive signal may be provided by the smart device, the smart device may vibrate, a pop-up message may be generated indicating which monitored system or systems need to be inspected and provided with water, or an indication light, like a LED-light may be switched on or may flash. In the alternative, a dedicated device (e.g., being in the form of a keyholder or alike) may receive the signal and alert the user through for instance a light signal, a message, a vibration signal, an auditive signal or alike. Optionally an e-mail or text message may be generated and sent to an e-mail address of the user.

According to some embodiments, the monitoring means may comprise a camera configured to make an image of the position of the floating means, the image corresponding to said monitoring result.

In a second aspect, the invention pertains to a method for monitoring the water level in a hydroponic system, using a water monitoring system according to the first invention. The method comprises steps of measuring the magnetic field of the magnet in the floating means with the monitoring means, and the processor processing the magnetic field into a water level for the user.

Further embodiments of the method are described in the first aspect of the invention, such as determining the magnetic field via a plurality of measurements over a limited time span and averaging these measurements into a single value which is then processed into a water level. Another embodiment provides for a calibration, in which the system automatically calibrates itself when detecting a constant magnetic field over a time frame longer than a predetermined time, and automatically associates said constant magnetic field value to the lowest, empty state of the water level. Another embodiments provides for the use of multiple magnetometers which are positioned at an essentially equal height, but different horizontal position. The discrepancy in the measured magnetic fields can be used to determine a more exact position of the magnet and can compensate for deviations due to skewness of the floating means, possible external influences, and even malfunctions of one of the magnetometers. Another embodiment provides for the system to automatically send a signal (auditive, message, vibration, visual, . . . ) to a user when predetermined conditions are reached (for instance, empty state for at least 1 day; 10% full; etc.). These requirements can even be set or adjusted manually by the user.

The independent and dependent claims set out particular and preferred features of the invention. Features from the dependent claims may be combined with features of the independent or other dependent claims, and/or with features set out in the description above and/or hereinafter as appropriate. Features from one aspect of the invention may be combined with features of any other aspect of the invention as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

### EXAMPLES AND DESCRIPTION OF FIGURES

The present invention will be described with respect to particular embodiments. It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could.

Furthermore, the particular features or characteristics may be combined in any suitable manner in one or more embodiments, as would be apparent to one of ordinary skill in the art.

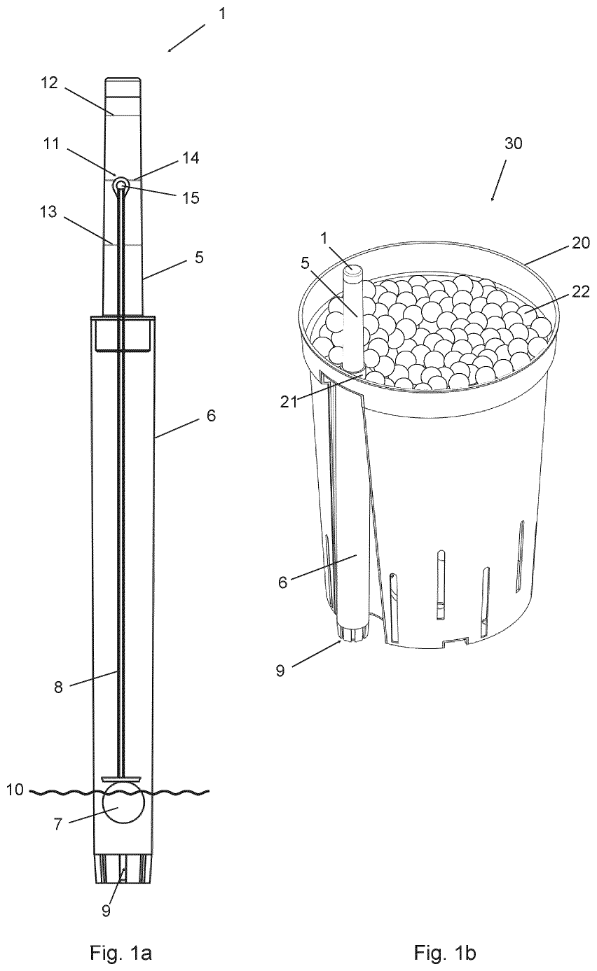

A water level monitoring system 1 as known in prior art, being part of e.g. a hydroponic system, such as a LECA system 30, is shown in FIGS. 1a and 1b. FIG. 1a shows the water level monitoring system 1, FIG. 1b shows a LECA type hydroponic system 30 in which the water level monitoring system 1 is provided. For clarity of the FIG. 1b, the plant and the outer casing of the hydroponic system is not shown. The hydroponic system 30, next to the not shown outer casing, comprises an inner pot 20, which has a position holder 21 where the water level monitoring system 1 can slide in from the bottom. The inner pot 20 is filled with expanded clay particles 22. The lower part of the water level monitoring system 1 is slid in the holder 21 until the interface between an upper tube part 5 and a lower tube part 6 reaches the holder. The holder prevents the combination of upper and lower tube part to slide further upwards. In mounted condition, the lower side of the water level monitoring system 1 extends in the water reservoir of the outer pot and is flush with the bottom of the pot 21. The water level monitoring system 1 is in fluid connection with the water reservoir of the outer pot of the hydroponic system and forms communicating vessels with this water reservoir. The lower side of the water level monitoring system 1 is coplanar with the lower side of the inner pot 20.

The water level monitoring system 1 comprises a floating means. The floating means comprises a tube, in this case the tube comprising an upper tube part 5 and a lower tube part 6. The upper tube part 5 is made of transparent polymer. The lower open end of the upper tube part 5 fits in the upper open end of the lower tube part 6. The lower tube part 6 may be provided from transparent polymer but may as well be made from non-transparent polymer. At the lower end of the lower tube part 6, openings 9 are provided which allow water to flow into the lower tube part 6. Via these openings 9, the lower tube part 6 is in fluid connection with the water reservoir of the hydroponic system. The more water in the water reservoir, the higher the water level in the lower tube part 6. The water reservoir of the hydroponic system and the tube work as communicating vessels. The actual water level in the hydroponic system 30 is indicated in FIG. 1a by the waterline 10. In the lower tube part 6, a polymeric ball 7 floats on the water which has entered the lower tube part 6. This ball 7 is contacted by a polymeric rod 8 at its upper side. The rod 8 extends into the upper tube part 5, where an indication means, being the top 11 of the rod 8, will be positioned between three marks present on the upper tube part 5, i.e. an upper mark 12 indicating the uppermost position of the top 11 of the rod 8 and a lower mark 13 indicating the lowermost position of the top 11 of the rod 8, and a middle mark 14 indicating an intermediate position. When the minimum or no water is present in the lower tube part 6, the top 11 of the rod 8 will be at the height of the lower mark 13. When the water tank of the hydroponic system is fully filled, the top 11 of the rod 8 will be pushed up to the upper mark 12. The rod 8 is typically a slender element made from brightly coloured polymer. The colour of the rod 8 preferably is red. At the top 11 of the rod 8, the rod 8 has a magnet 15 which produces a magnetic field.

The water level monitoring system 1 shown in FIGS. 1a and 1b is known as the “analog system”. Monitoring the water level using this water level monitoring system 1 is done visually and requires daily human inspection of the position of the top 11 of the rod 8 inside the tube. When the top 11 is at the lowest point for a given time, e.g. after 4 days, water need to be provided to the hydroponic system 30, thereby raising the top 11 of the rod 8 again until the rod 8 reaches its required position.

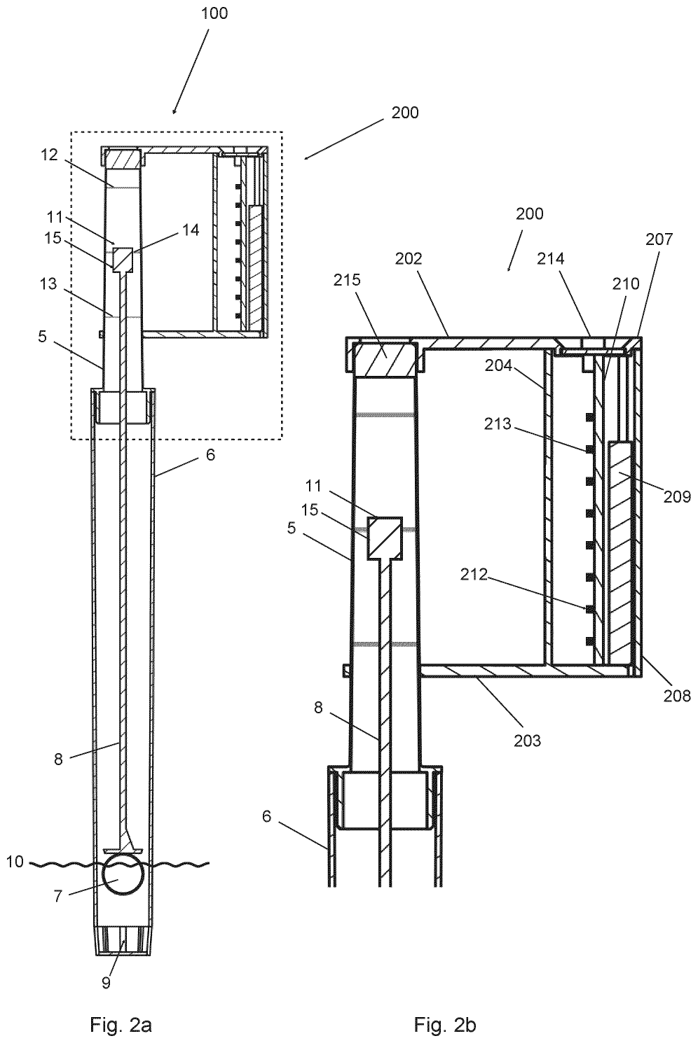

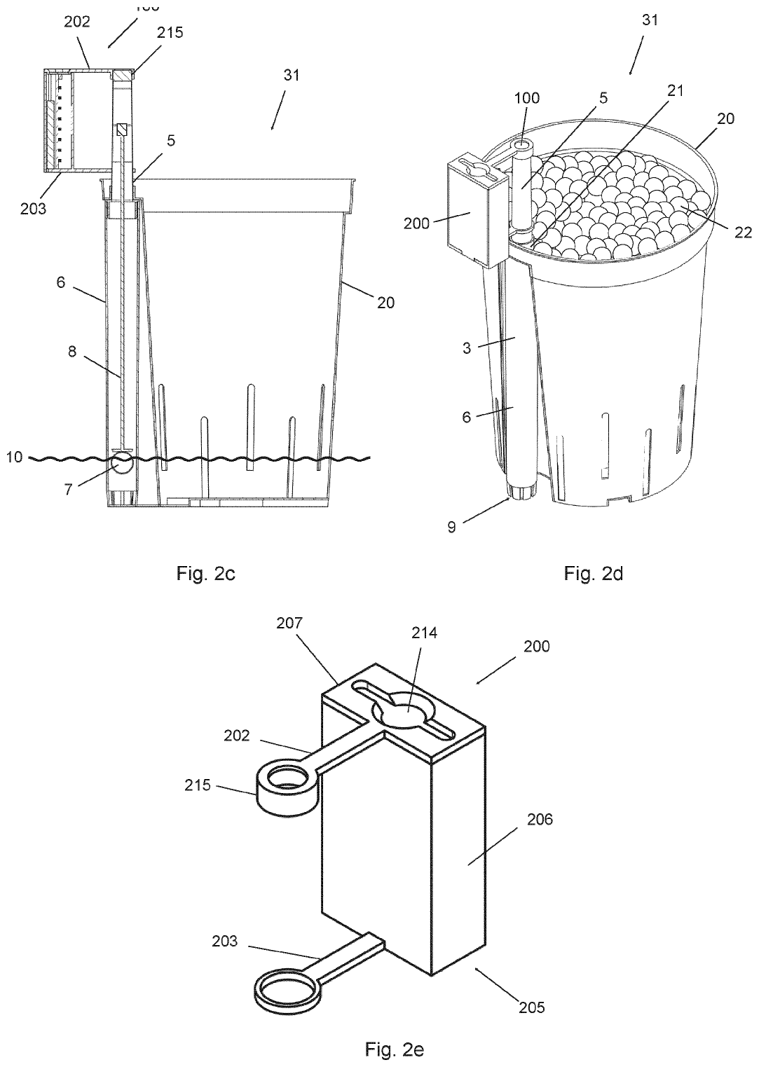

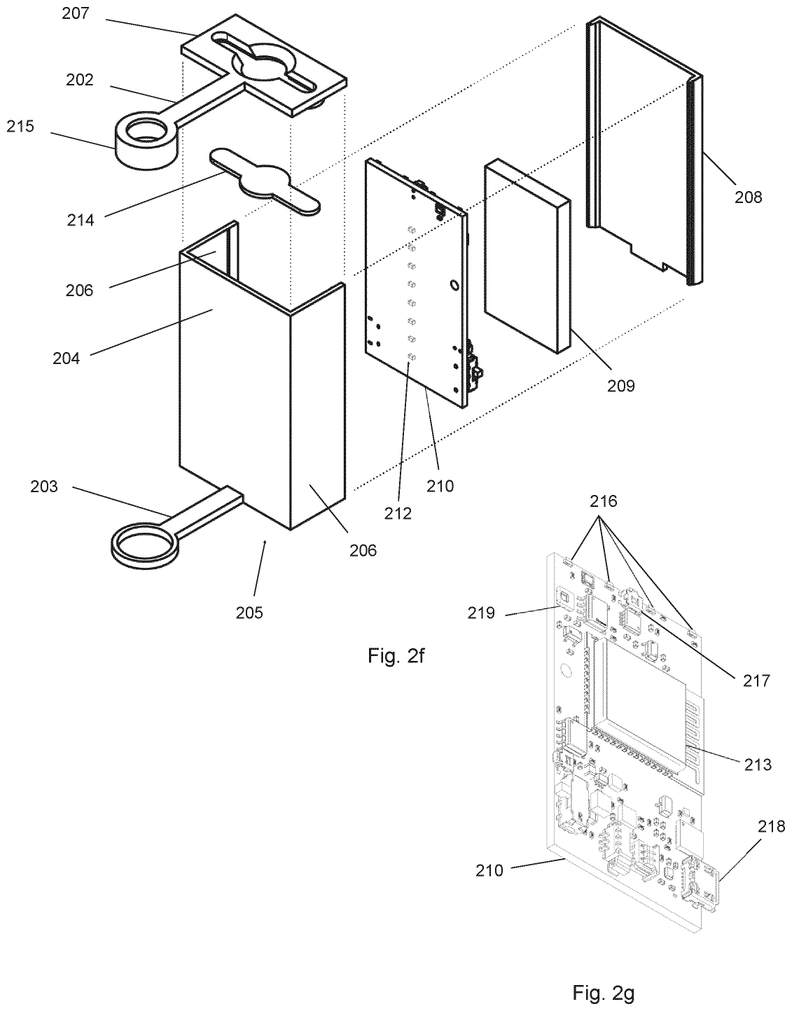

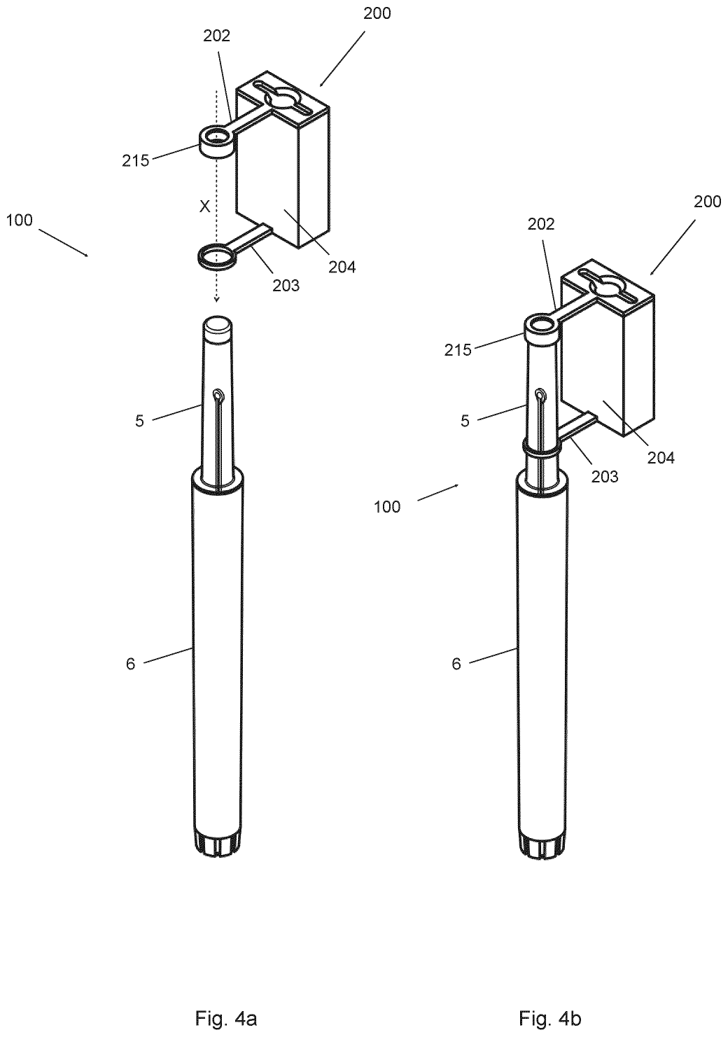

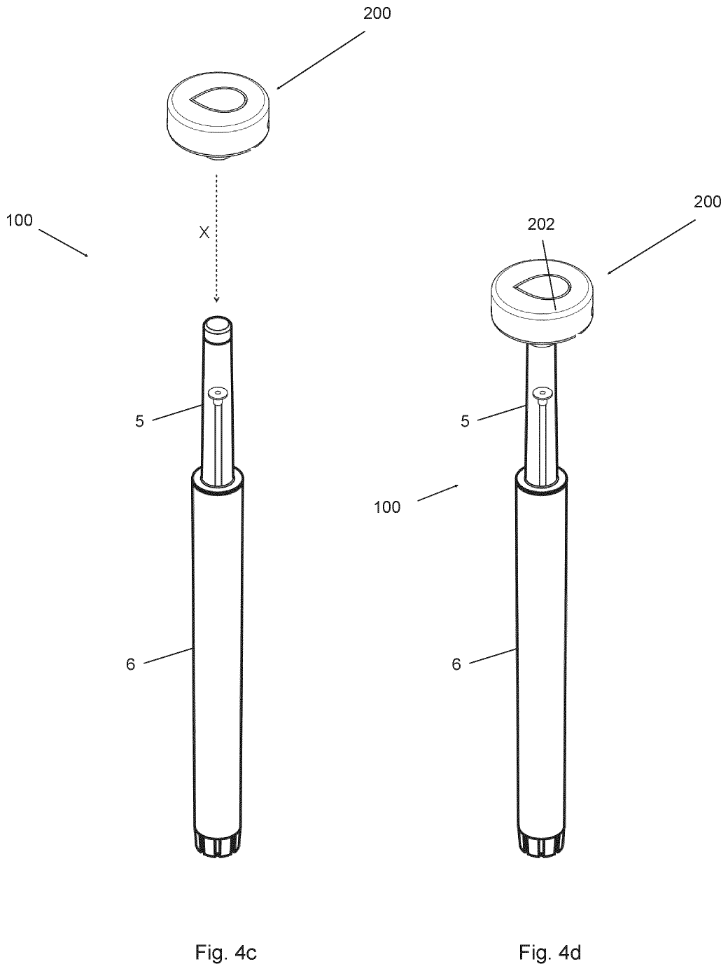

A water level monitoring systems according to the invention, being part of e.g., a hydroponic system according to the invention, as a first example with Hall sensors as magnetometers, is shown in FIGS. 2a, 2b, 2c, 2d, 2e, 2f, 2g, 4a, 4b. A detail of a water level monitoring system 100 according to the invention, which detail is encompassed by the dashed rectangle in FIG. 2a, is shown in FIG. 2b. The water level monitoring system 100 according to the invention as part of a hydroponic system 31 according to the invention being shown in FIGS. 2c and 2d. An isometric view of the monitoring means 200 of the water level monitoring system 100 is shown in FIG. 2e, whereas an exploded view of the components of the monitoring means 200 is shown in FIG. 2f. FIG. 2g shows the backside of the printed circuit board of the monitoring means 200.

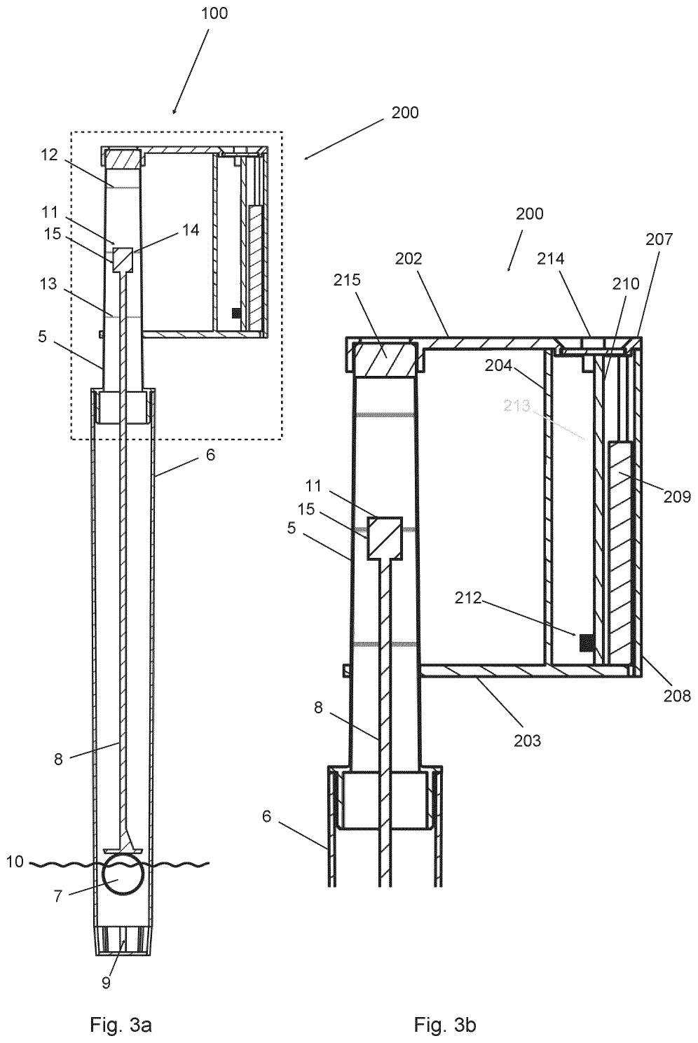

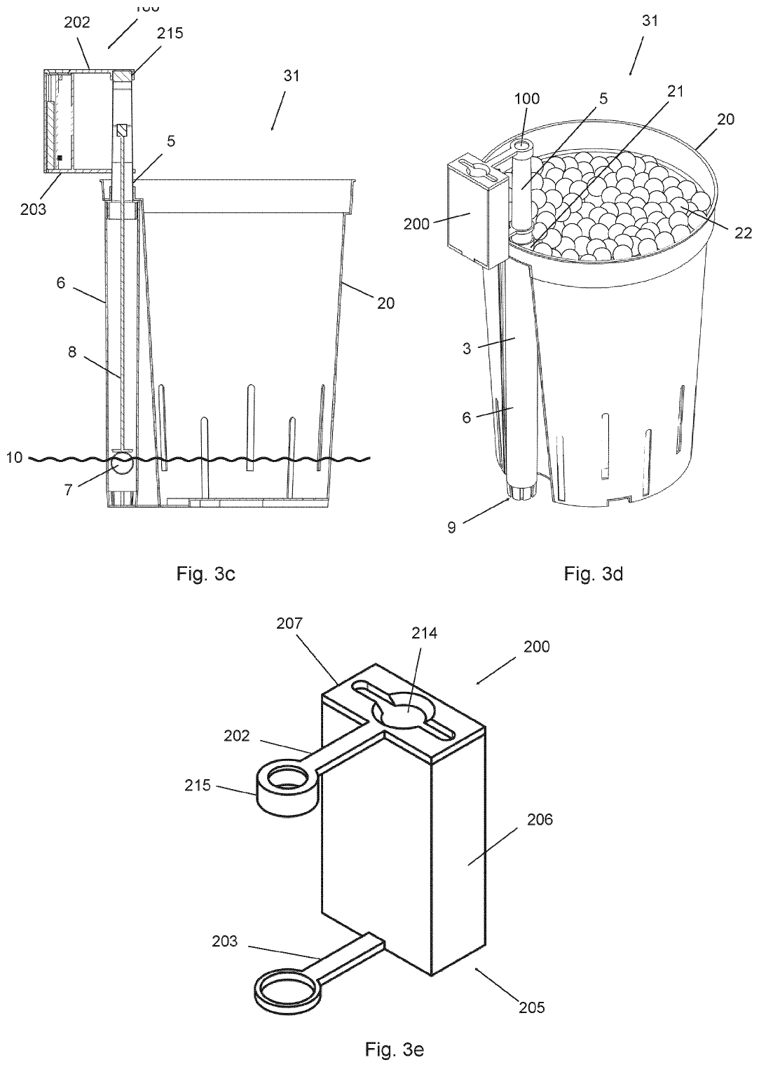

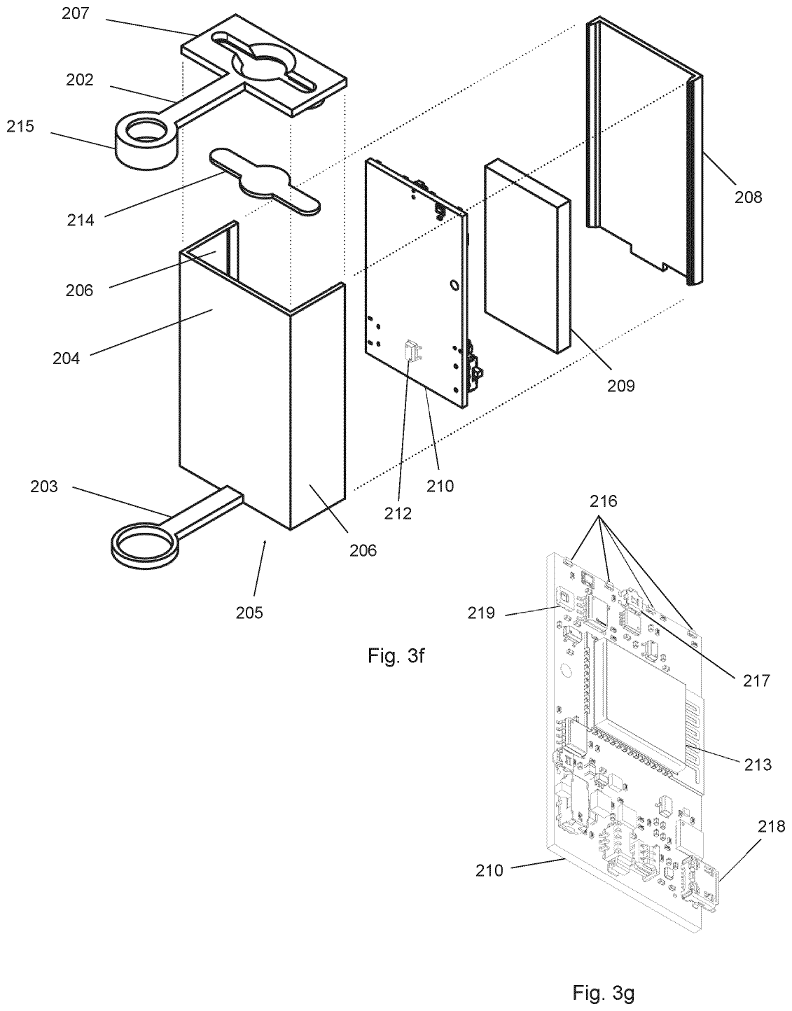

A water level monitoring systems according to the invention, being part of e.g., a hydroponic system according to the invention, as a first example with a MEMS magnetic field sensor as magnetometer, is shown in FIGS. 3a, 3b, 3c, 3d, 3e, 3f, 3g, 4a, 4b. A detail of a water level monitoring system 100 according to the invention, which detail is encompassed by the dashed rectangle in FIG. 3a, is shown in FIG. 3b. The water level monitoring system 100 according to the invention as part of a hydroponic system 31 according to the invention being shown in FIGS. 3c and 3d. An isometric view of the monitoring means 200 of the water level monitoring system 100 is shown in FIG. 3e, whereas an exploded view of the components of the monitoring means 200 is shown in FIG. 3f. FIG. 3g shows the backside of the printed circuit board of the monitoring means 200.

FIGS. 4a and 4b show how a monitoring means 200 being part of the water level monitoring system 100 can slide over a floating means, which may optionally be a floating means according to the prior art. FIGS. 4c and 4b show the same for a cap-type monitoring means 200, which can be attached at the top of the floating means (specifically, the tube holding the floating body).

The water level monitoring system 100 comprises a floating means being similar if not identical to the floating system of FIGS. 1a and 1b. Parts with identical references refer to an identical or similar element in the water level monitoring system 100 and accompanying floating means.

The water level monitoring system 100 comprises a monitoring means 200. This monitoring means 200 can be used on floating means known in the prior art. As shown in FIGS. 4a and 4b, the monitoring means 200 fits on the upper tube part 5 by a holding means, the holding means being adapted to be securely attached to the tube of the floating means. The holding means comprises a top lever 202 and a lower lever 203. The lower lever 203 is provided with a ring which can slide over the upper tube part 5 of the floating means. The upper lever 202 is provided with a cap 215 which fits on the upper tube part 5 of the floating means. The cap 215 prevents the upper lever 202 from sliding beyond the top of the upper tube part 5. The cap 215 fixes the holding means, and hence the monitoring means 200 on the upper tube part 5. The lower lever 203 has at its outer end a ring which fits over the upper tube part 5 and will guarantee a distance between front plate 204 of the monitoring means and the upper tube part 5 to remain constant. The monitoring means 200 hence can slide in the axial direction X of the tube over the upper tube part 5 until the cap 215 fits the top of the upper tube part 5.

FIGS. 4c and 4d show a circular monitoring means 200, which is mounted on top of the upper tube part 5. This can be via a screw connection, or simply a clamping fit of the monitoring means 200 on the tube 5, as well as other means.

As shown in FIGS. 2 to 4, the front plate 204 is part of a cover box 205 which further comprises two side walls 206, a top wall 207 and a back wall 208 and a bottom wall. Within this cover box 205, a battery 209 is located, as well as a printed circuit board 210. A printed circuit board is also referred to as a PCB. The cover box's 205 elements may be provided from polymeric material.

On the board 210, a plurality of electronic elements are provided. A first example is given in FIGS. 2a to 2g, whereby multiple magnetometers 212, e.g. Hall sensors, are positioned on this board. The magnetometers 212 are located close by the magnet 15, preferably less than 20 mm, more preferably less than 10 mm, most preferably less than 2 mm, and are attached to the front plate 204. The Hall sensors 212 are triggered upon exceedance of a certain magnetic field threshold. The measurement is discrete, either a Hall sensor is on or off. The rod 8 is located along the upper tube part 5. The position of the triggered Hall sensor 212 define the position of the magnet 15 and consequently the water level.

A second example is given in FIGS. 3a to 3g, whereby one magnetometer 212, e.g. a MEMS magnetic field sensor, is positioned on this board. The magnetometer 212 is located close by the magnet 15, preferably less than 20 mm, more preferably less than 10 mm, most preferably less than 2 mm, and are attached to the front plate 204. The MEMS magnetic field sensors 212 is measuring analogue values of the magnetic field produced by the magnet 15. Based on the analogue value of the magnetic field, a corresponding digital signal is produced. The rod 8 is located along the upper tube part 5. The value of the MEMS magnetic field sensor 212 defines the strength of the magnetic field produced by the magnet 15. Consequently, the position of the magnet can be defined corresponding to the water level.

The PCB 210 further comprises a processor 213 which may be configured to process this monitoring result and determine therefrom a water level for the hydroponic system. The PCB 210 further comprises an alerting unit configured to generate an alert signal based on said water level, in this case a visual alert by means of switched-on or flashing LED light(s) 216. The PCB 210 further may comprise a transceiver, USB loading point 218 for the battery, a time keeping means, a light sensor, a temperature and humidity sensor 219, a power switch and alike.

The cover box may also be provided with additional tools, such as a button 217, and alike. As an example, the top wall is provided with an opening, closed by a closing element 214 made out of transparent or translucent polymer. Under the closing element 214, the LEDs 216 and a button 217 are provided. The button is used to force the water level monitoring system to make a measurement, i.e. to take an image and process this image in order to get information on the water level in the hydroponic system.

In this embodiment, the processor 213 to determine a water level for the hydroponic system is provided as an on-board processor. The processor 213 is configured to process the obtained image and determine therefrom a water level for the hydroponic system. This processing may be based upon one or more DSP algorithms executed by the processor 213. In the alternative, AI/ML is stored on-board and used by the processor 213 to determine from the image a water level for the hydroponic system.

An alerting unit configured to generate an alert signal based on said water level is located on the board as well. The board may comprise a transceiver, to send a signal to a smart device, through a close proximity communication system or through the internet.

This water level monitoring system 100 has the advantage that it may use the floating means of existing hydroponic systems. As shown in FIGS. 4a and 4b, the monitoring means may be mounted on the existing floating means without any manipulation of the floating means itself. The water level monitoring system 100 will function without the need for internet communication thanks to the processor 213 on-board and may provide the user with a signal through a close proximity communication system.

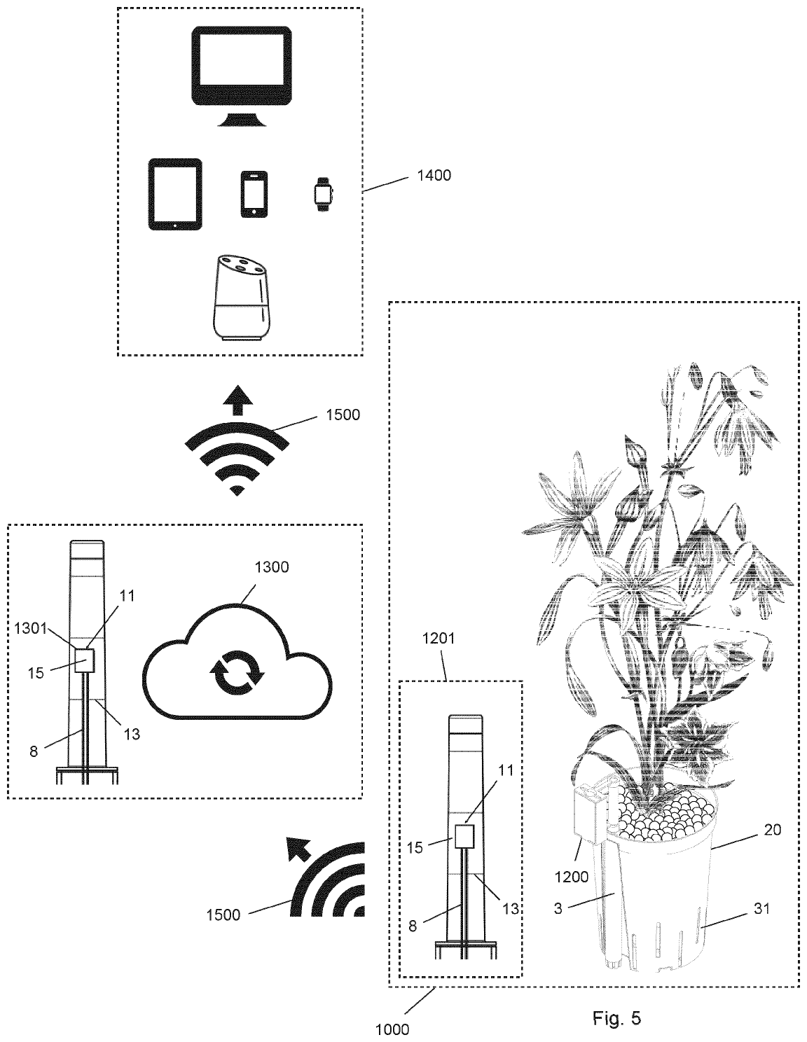

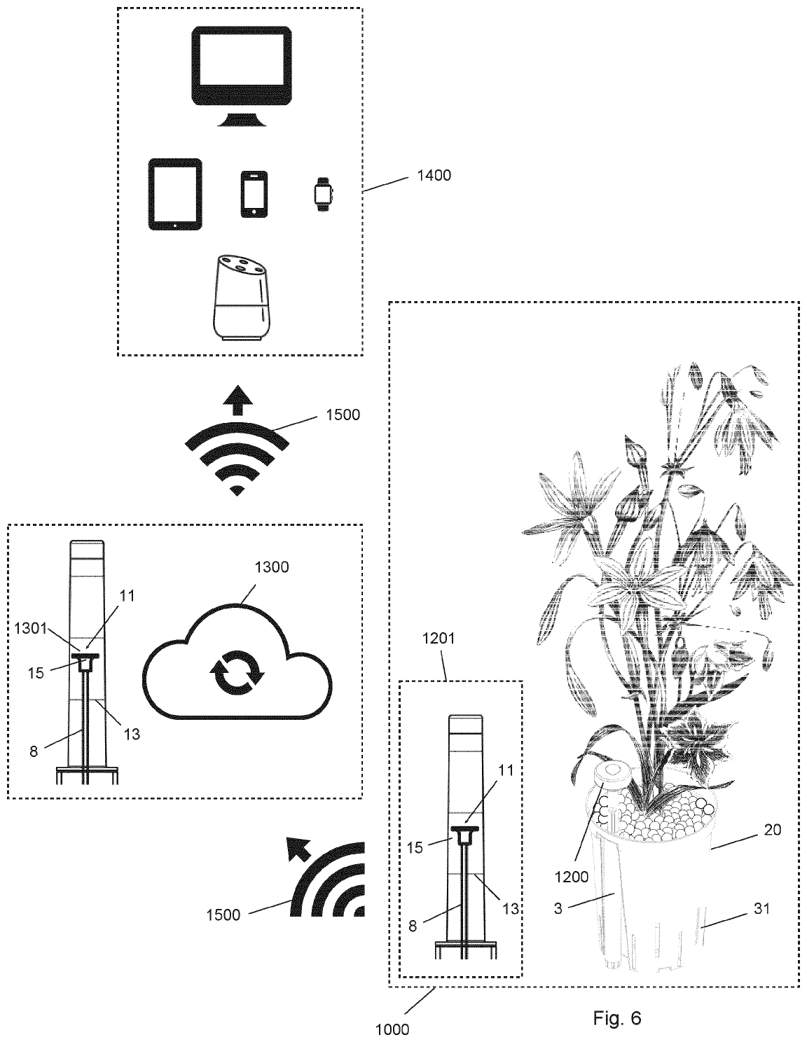

A water level monitoring system 1000, being an alternative for the water level monitoring systems with an on-board processor is shown in FIG. 5 and FIG. 6. The monitoring means 1200 is similar to the monitoring means 100 shown in FIGS. 2 to 4 and 7, but the mere difference is that the monitoring means 1200 is provided with a transceiver to send the image taken to a processor located in the cloud 1300.

The processor in the cloud is configured to process the signals from the magnetometers, and determine therefrom a water level for the hydroponic system. An alerting unit configured to generate an alert signal based on said water level is located in the cloud as well. The alert unit sends a signal to one or more smart devices 1400, which signal is indicative for the water level of the hydroponic system, and optionally indicates actions to be taken. The communication between processor in the monitoring means and the processor in the cloud 1300, and between the alerting unit in the cloud and the smart devices 1400 may be done using communication techniques 1500 like WIFI, 4G, 5G or narrow band IoT wireless networks. The alert signal may be sent back to the monitoring means, which can trigger a local alert signal, like switching on or flashing a visual signal like a LED and/or switching on an auditive signal.

The processor, either on-board or in the cloud, and being configured with a digital signal processing algorithm to process the monitoring result and determine the water level, may use several consecutive steps to process the image into a monitoring result being a position of a floating means, and to process this result into a water level for the hydroponic system. As an example, the image taken may be filtered on colour. The rod has usually a typical colour, most often red. The image taken may be filtered on this typical colour, e.g. red, while all other colours are removed. Only the red colour of each pixel is kept. The filtered image may be scanned from top to bottom, with the intent to locate the uppermost pixel, or uppermost horizontal sequence of a given number of adjacent pixels, having a red colour with intensity above a given threshold. This uppermost pixel or uppermost sequence of pixels is indicative for the top of the rod in the image taken. The number of pixels between the upper edge of the image and this uppermost pixel, or uppermost sequence of pixels, may be used as monitoring result. As the position of the monitoring means is fixed vis a vis the floating means' tube, the minimum position and the maximum position of the rod is linked to a given minimum and maximum pixel number where the top may be noticed. The value of the number of pixels between the upper edge of the image and this uppermost pixel, or uppermost sequence of pixels can be compared to this minimum and maximum pixel number. A water level for the hydroponic system can be calculated based upon the differences between the number of pixels between the upper edge of the image and this uppermost pixel, or uppermost sequence of pixels, and the minimum and maximum pixel number.

An alternative digital signal processing algorithm to process the monitoring result and determine the water level may make use of an enlargement of the rod, usually a ring-like element, near the top of the rod. The opening of the ring-like element corresponds the water level in the lower tube part. As an example, first the colour separation step may be used, where the captured image is filtered on the typical colour of the rod, usually red. In a subsequent step, a contour detection is done, where the contours of the rod, and the enlargement, is made available. In a next step, the widest points of its enlargement will be determined, as well as the upper and lower point of the enlargement. These points, or pixels with given coordinates in the image, may be used to define a rectangle being the bounding box, each of these pixels being part of one of the sides of this rectangle. The bounding box is the smallest rectangle encompassing the enlargement of the outer end of the rod in the image taken. Calculating the centre of the rectangle will provide the pixel being the middle of the enlargement, which pixel is the measuring result. A water level for the hydroponic system can be calculated based upon the differences between the position of the centre pixel and the minimum and maximum pixel position for the centre of the enlargement.

In other embodiments, the processor, either on-board or in the cloud, is configured using AI/ML to process the monitoring result and determine the water level. The AI/ML algorithms may be build using the software from TensorFlow. As an example, and as shown in FIG. 5 and FIG. 6, the signal 1201 produced by the magnetometer is provided to the AI/ML algorithm, which processes the image into a position of the floating means. The AI/ML may determine, in the image taken 1201, the bounding box 1301 which is the smallest rectangle encompassing the magnet (or enlargement) 15 of the outer end 11 of the rod 8 in the image taken. The position of the floating means may be a pixel with given coordinate in the image taken, e.g., the upper pixel of the bounding box 1301 or the centre of the bounding box 1301. A water level for the hydroponic system can be calculated based upon the differences between the position of this pixel and the minimum and maximum pixel corresponding to the empty and fully filled hydroponic system, using DSP algorithms.

Alternatively, the water level for the hydroponic system can be obtained from this position of the floating means using a second AI/ML algorithm.

Using these embodiments as shown in FIGS. 2 to 5 have the advantage that the user gets a signal while this user does not need to inspect and follow up the water level of the monitored hydroponic systems on a regular basis. Additionally, the analog system still provides the user with an instant indication of the water level during refilling of the hydroponic system.

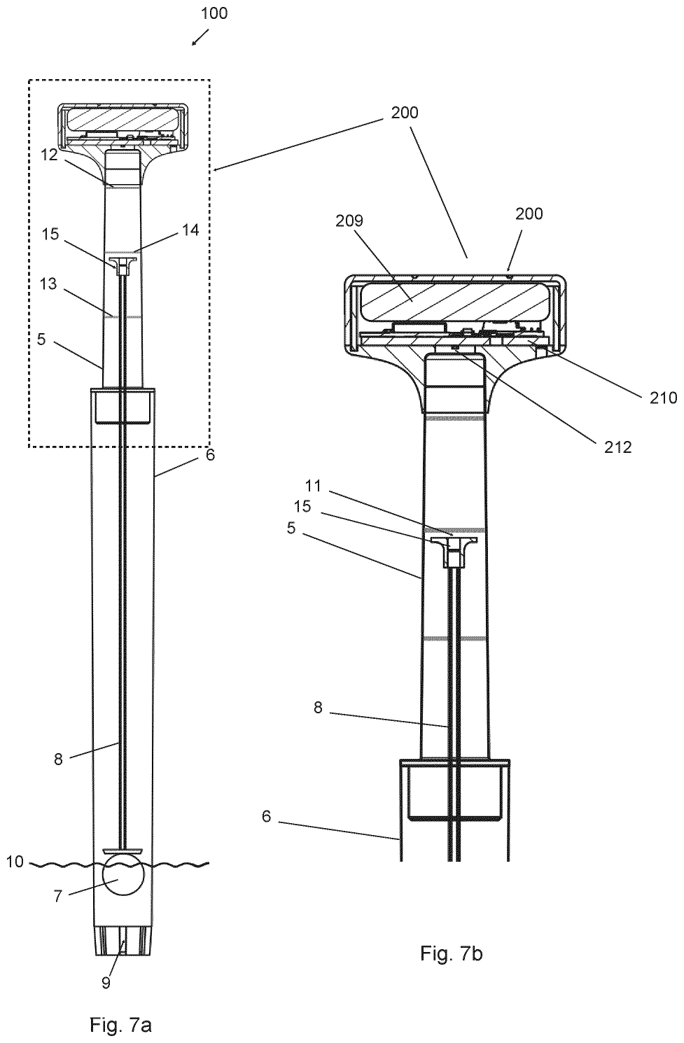

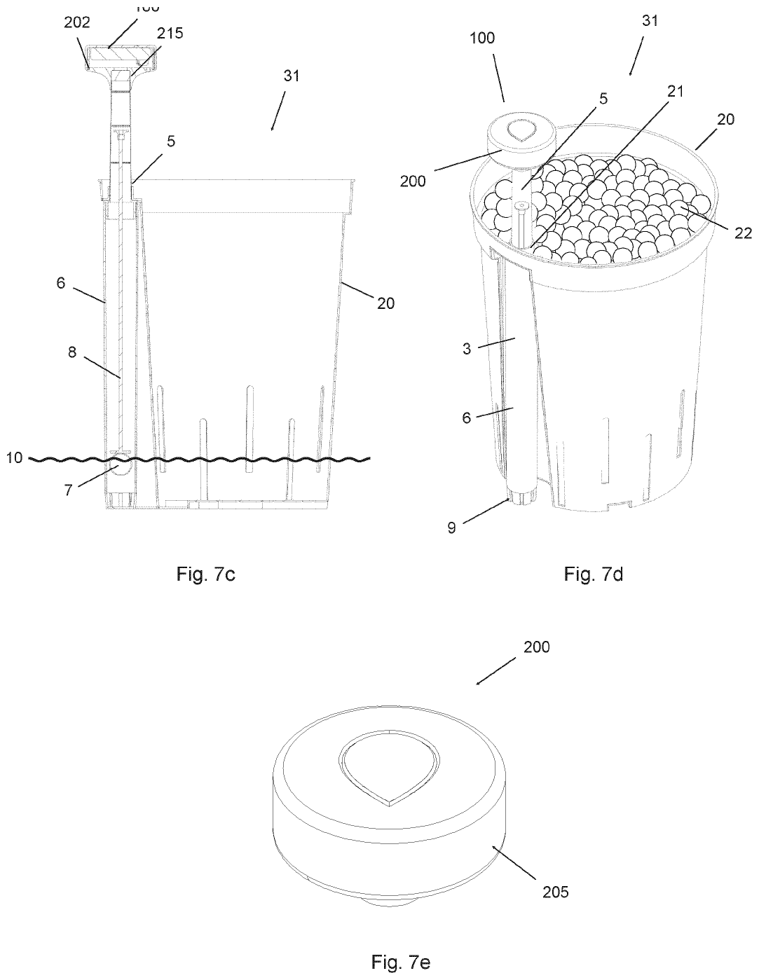

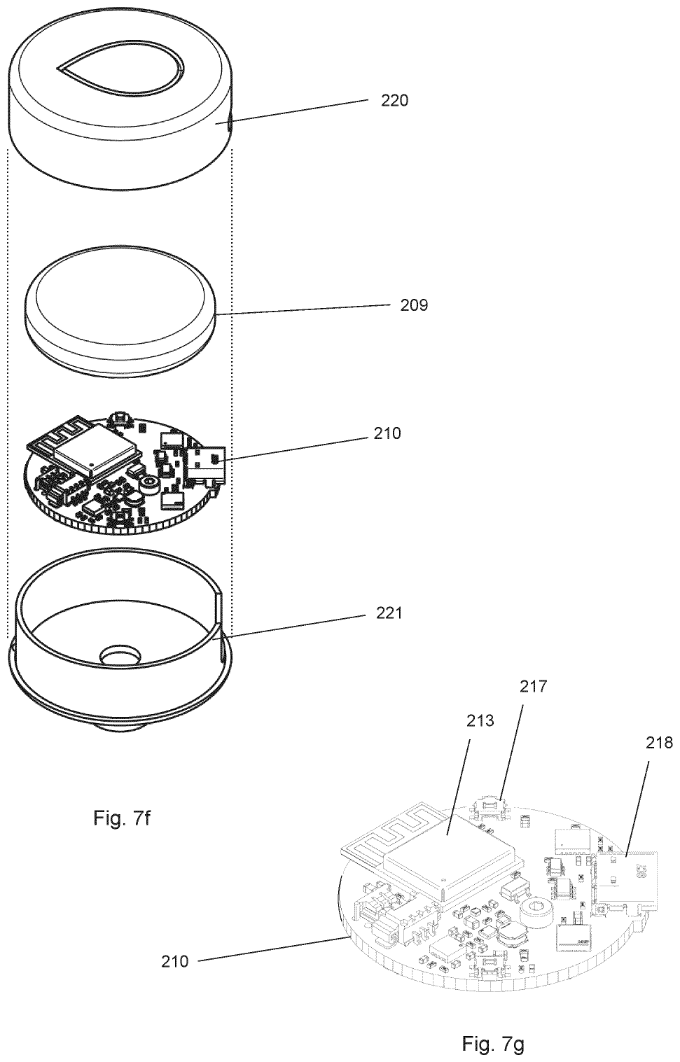

A water level monitoring systems according to the invention, being part of e.g., a hydroponic system according to the invention, as a first example with a MEMS magnetic field sensor as magnetometer, is shown in FIGS. 7a, 7b, 7c, 7d, 7e, 7f, 7g, 4c, 4d. A detail of a water level monitoring system 100 according to the invention, which detail is encompassed by the dashed rectangle in FIG. 7a, is shown in FIG. 7b. The water level monitoring system 100 according to the invention as part of a hydroponic system 31 according to the invention being shown in FIGS. 7c and 7d. An isometric view of the monitoring means 200 of the water level monitoring system 100 is shown in FIG. 7e, whereas an exploded view of the components of the monitoring means 200 is shown in FIG. 7f. FIG. 7g shows the backside of the printed circuit board of the monitoring means 200.

The specific setup of the monitoring means of FIG. 7 follows that of the other variants described in FIGS. 2 and 3 in a general way, with similar or the same components being used, but with the orientation or position being adapted such that the monitoring means can be positioned on top of the floating means. As can be seen in FIG. 7f, the “cover box” for the circular top monitoring means 200, is provided by a bottom part 221 and a top part 220, which encapsulate the electronics, such as the battery 209 and the PCB 210.

It is to be understood that although preferred embodiments and/or materials have been discussed for providing embodiments according to the present invention, various modifications or changes may be made without departing from the scope and spirit of this invention.

1. A water level monitoring system for monitoring a water level in a hydroponic system, the water level monitoring system comprising:
a floating means, comprising a floating body and at least one magnet, said water level monitoring system being adapted to monitor the position of said floating means;
a monitoring means for monitoring the position of said floating means floating on the water level in a hydroponic system and generating a monitoring result, based on a magnetic field produced by said at least one magnet;
a processor configured to process said monitoring result and determine therefrom a water level for the hydroponic system; and
an alerting unit configured to generate an alert signal based on said water level;
wherein the processor is configured to calibrate itself by automatically determining the water level to be at a lowest, empty state when the monitoring results remain substantially constant for at least a predetermined period of time, and wherein future water levels are determined from future monitoring results taking into account the monitoring results associated to said lowest, empty state.

2. The water level monitoring system according to claim 1, wherein the determination of the monitoring results remaining substantially constant for at least the predetermined period of time is performed by comparing the monitoring results during said predetermined period of time with an average of the monitoring results over a preceding predetermined length of time, said length of time being longer in duration than the preceding predetermined period of time, said preceding predetermined length of time preferably being directly preceding to the predetermined period of time.

3. The water level monitoring system according to claim 1, wherein the at least one magnet is provided in an elongate tube, and the water level monitoring means further includes:
a holding means holding the monitoring means, the holding means being adapted to be securely attached to the tube at a superior end thereof, and
wherein the monitoring means comprises a main magnetometer and one or more support magnetometers, wherein the main magnetometer and the one or more support magnetometers are distanced differently from the longitudinal axis of the tube, and
wherein the processor takes into account the monitoring results of the main magnetometer and of the one or more support magnetometers to determine the water level.

4. The water level monitoring system according to claim 3, wherein the monitoring means is positioned at the superior end of the tube, and wherein the main magnetometer is positioned on the longitudinal axis of the tube, and wherein the one or more support magnetometers are positioned off-axis from the longitudinal axis of the tube.

5. The water level monitoring system according to claim 1, wherein the processor is configured to determine the water level based on a plurality of measurements of the magnetic field by the monitoring means, said plurality comprising at least 5 samples or, preferably at least 10 samples, wherein said measurements are taken over a maximal time frame of 1 minute or preferably of 30 seconds, and most preferably wherein the water level is determined based on an average of said plurality of measurements.

6. The water level monitoring system according to claim 1, wherein said monitoring means comprises one or more magnetometers, configured to detect said magnetic field of said at least one magnet, and wherein said water level is determined by the strength of said detected magnetic field.

7. The water level monitoring system according to claim 1, wherein said monitoring means comprises at least two magnetometers, positioned at predefined intervals, and configured to detect said magnetic field of said at least one magnet, and wherein said water level is determined by the strength of said magnetic field detected by at least one, preferably each, of the at least two magnetometers.

8. The water level monitoring system according to claim 6, wherein said magnetometers are Hall effect sensors, configured to act as a binary switch and to trigger upon exceedance of a magnetic threshold of said magnetic field and wherein said water level is determined by said triggered Hall effect sensor.

9. The water level monitoring system according to claim 6, wherein said magnetometer is a micro-electro-mechanical system (MEMS), or more specifically a MEMS magnetic field sensor.

10. The water level monitoring system according to claim 1, wherein the floating means comprises at least a tube, comprising an indication means.

11. The water level monitoring system according to claim 10, wherein said water level monitoring system is adapted to monitor the position of said indication means.

12. The water level monitoring system according to claim 1, wherein the water level monitoring means comprises a holding means holding the monitoring means, the holding means being adapted to be securely attached to a tube of a floating means of a hydroponic system.

13. The water level monitoring system according to claim 1, wherein said processor is configured with artificial intelligence and machine learning to process said monitoring result and determine said water level.

14. The water level monitoring system according to claim 1, wherein said processor is an on-board processor integrated with said monitoring means into a single unit.

15. The water level monitoring system according to claim 1, wherein said processor is a remote processor and the monitoring result is transferred via a communication network.

16. The water level monitoring system according to claim 1, wherein said alerting unit comprises a communication means to communicate said alert signal to a smart device that is configured with an application to alert a user based on said alert signal.

17. The water level monitoring system according to claim 1, wherein said alert signal is a visual and/or auditive signal.
